(19) United States
(12) Patent Application Publication
(10) Pub. No.: US 2008/0252642 A1
(43) Pub. Date: Oct. 16, 2008

(54) Method and Drug Administration Device For Enhanced Display of Diary Data

(75) Inventors: Jon Ulrich Hansen, Herlev (DK); Knud Poulsen, Kobenhavn NV (DK); Hans Henrik Thodberg, Holte (DK)

Correspondence Address: NOVO NORDISK, INC.;INTELLECTUAL PROPERTY DEPARTMENT, 100 COLLEGE ROAD WEST, PRINCETON, NJ, 08540, US

(73) Assignee: Novo Nordisk A/S, Bagsvaerd (DK)

(21) Appl. No.: 11/630,453

(22) PCT Filed: Jul. 1, 2005
(86) PCT No.: PCT/EP05/53131

§ 371 Date: Jan. 2, 2008

(30) Foreign Application Priority Data
Jul. 1, 2004 (DK) PA 2004 01040

(51) Int. Cl. G06T 11/20

(52) U.S. Cl. 345/440

(57) ABSTRACT

The invention provides for a method and a drug administration device for enhanced display of data in a modal day format. The method in accordance with the invention provides the user with an option to select one or more data points (430) on the graph and on selection all the corresponding points (to the selected points) are marked (440) giving an insight into the dairys' data.

### FIELD OF THE INVENTION

The present invention relates to a method for graphically displaying diary data in a modal day format, this relates to the field of health management and in particular, self-medication and treatment. More particularly the invention relates to the field of an automated system for displaying diary data.

Further the present invention relates to a drug administration device and a computer program product on which said method can be carried out.

### BACKGROUND OF THE INVENTION

Health problems can be classified as acute or chronic. Acute diseases are one time problem with the body that can be solved by a treatment for a certain period of time and with the help of medication, surgery etc.

Chronic diseases on the other hand are the problems encountered by a body because of some physiological or metabolic imbalance. These imbalances are difficult to rectify and thus require treatment, i.e. they should be dealt with in some way to increase the longevity of the subject. Therefore in chronic diseases not only does the subject need to take regular medication and other treatment but also needs to monitor his lifestyle i.e. living habits, food, activity pattern, etc.

Diabetes is one of such chronic diseases. Lack of insulin (which normally for a non diabetic patient is produced by the pancreas in a proper amount) in the body results in a rise of the blood sugar level, which in turn has various effects, such as excessive thirst, frequent urination, weakness and excess of ketones in the bloodstream.

In order to keep the blood sugar level at an appropriate level, diabetics take doses of insulin at regular intervals of time, i.e. one or more times each day. However this is not a cure but just a part of the treatment. A diabetic Health Management program would typically involve other elements, such as regular exercise, food intake monitoring etc. A balance between the food intake and exercising etc has to be maintained so as to make the body behave as close as possible to a normal body.

In advanced treatment setups, a diabetes team will support the patient and teach how to treat diabetes safely and effectively. However the impetus is on the patient himself to manage his life with diabetes. With the increasing cost of medical care with each passing day and life getting busier (with not even having time to spare to visit a doctor), the focus has now shifted to devices and means that help the patient take care of his needs. The need was addressed by the introduction of portable self-operated drug administration devices. These devices are not only easy to use but also safe. For example devices to inject insulin (for diabetes patients), inhalers (for asthma patients and for diabetic patients as well), blood sample collection device etc are widely available in the market. International Publication Numbers. WO 00/32088, WO 03/005891 and WO 03/015838 all describe such medical devices, networks and method of their operation along with some of the possibilities in the domain. These publications are incorporated herein in entity by way of reference.

However as mentioned above, diseases like diabetes not only requires regularly medication every day but also requires a regular monitoring of the medication as well as the tracking of the lifestyle followed by the patient. An obvious solution to this is by maintaining a log book of the parameters to be monitored. For example, the diabetic patient can keep track of the parameters which may include food, medication, blood glucose level(s), exercising, etc. in a diary. Before the advent of the computers in our personal life sphere, these records or the diary were to be manually maintained and thereafter analyzed, when the need arose.

Computers and the introduction of advanced software packages (especially made for diabetes patients) have eased the life by not only providing a ready interface to enter data but also to view the reports in various formats and to enable the user easily to study and analyze the recorded facts and figures. Such collection of data and reports are not only useful for a patient to monitor for his betterment but also provides a doctor or other healthcare personal with an insight into his patient's behavior (from the diary) and subsequently to improve or just to give recommendations for the treatment.

The use of computers has also introduced the possibility of charting out data in the form of graphical formats, such as bar graph, pie chart, line graph, etc. These visual interpretations are much easier to interpret. These kinds of diabetes diary software that are used for personal management are well known in the art. For instance DIABASS mobil offers complete diabetes data management and can be operated on a Palmtop computer.

Some of these software solutions can also interact/communicate with the advanced drug administration devices and download the data stored in these devices. As explained in the previously mentioned International Publication Numbers, these advanced devices can store information like the dosage administered, time and date of dosage as well as can have a reminder system for the patient's benefit. Upon communication between these devices all the data stored can be downloaded on to the computing device (on which these software are running) and be used (either by itself or along with additional data input by the user) for generating reports. For example MiniMed Solutions' MMT—7311 is one such advanced software that retrieves the data from the insulin injection pump to a store on PC which then can display data in various reports. Another example is software from Proactive Metabolics that function as a health manager and can help in planning meals, exercises and other personal aspects of a patient's life.

The central goal of all these software is to enable the maximum meaningful extraction of information from data that is stored on the computing device. One such useful kind of report/graph is a display of a Modal Day Report. In this kind of display, data for several days are displayed versus the time of the day, thus superimposing many days, which allows the user to spot patterns in the data.

The modal day view can be displayed for several types of diary data such as:
1. Blood glucose (concentration, mmol/l)
2. Insulin Injections (IU, International Units)
3. Meal (amount of glucose/meal size)
4. Exercise (intensity and duration).

This daily trend plot helps in glycaemic control vis a vis the daily activities of the patient.

In a modal day a user (patient/analyst/doctor) can select the period range, i.e. day, week, month, quarter, year etc. A target/desirable range can be decided and the analysis of points can be done keeping those points into consideration. The software can also generate a statistical summary report.

However the drawback with the existing solutions is that they do not identify the points on the graph i.e. date of the reading is not displayed on the graph because of space constraints. Once a user detects some spike or any other anomalous points in the graph, it is desirable that the user can identify the corresponding points from the same day/s. The present software solutions do not cater to this problem.

To overcome the drawbacks of the prior art and to solve said problem, the present invention provides for a method, further the present invention provides a drug administration device and a computer program product on which the method can be carried out, said method provides the following steps:
selecting one or more data points of one or more of the diary data by the user, said points representing data from one or more dates, and
marking all other data points corresponding to the dates of the selected points.

Thus, the present invention provides a method and drug administration device of/for graphical display of diary data with a functionality of selecting the desired data points in the graph.

The invention also provides for the automatic marking of the selected data points as well as data points corresponding to those selected.

It is an advantage that the marking of diary data identify related points, i.e. other corresponding data points.

The invention is thus is a way of summarising retrospective diary data in a visual presentation for doing trend analysis of the data. For a person with diabetes as for other people there is a very strong 24 hour cycle of doings (as will be shown as a prerequisite and as a background for understanding the invention later) as well as a weekly cycle. The inventions' view is an alignment of data by time of day, using the date information only to select the data range to be displayed. It is therefore a powerful tool to capture and visualise habits—good or bad—related to meals and insulin taking, and to exercise performed with the resulting glucose levels measured.

The invention provides a graphical display of blood glucose, insulin and food data of several days. Additionally, exercises performed may be taken into account. Data are superimposed in a day view (24-hours) or in a week view (1-week) display.

The invention only has a very little mathematical complexity. The invention can be carried out on a drug administration device or as a PC application. As an example, data from the drug administration device may be transferred to the PC for analysis and subsequent displaying.

The inventions' Modal Day view can be used for doing trend analysis of the data. To illustrate this, consider these user scenarios using the blood glucose measurements:

The user feels a little dizzy Friday morning and recognizes that this maybe also was the case last Friday. The user turns on the Modal Day view with setting of displaying the BGM, blood glucose measurements for the last 5 Fridays. The Modal Day view makes it clear for the user that the blood glucose is always (or at least the last 5 Fridays) low on Friday mornings. This will make the user think if something affecting the blood glucose is happening on Thursdays; and yes the weekly football practise is on Thursdays after hours, and usual this is ended with a friendly third half and some beers which mostly not properly matched with sufficient carbohydrate intake. Thus he may need to adjust his treatment:

The user goes to the quarterly check up at the clinic and the HCP, Health Care Personal finds an elevated HbA₁c. The HCP switch the drug administration device into Modal Day view to see if the elevated HbA₁c origin from a general high blood glucose level or if there is a problem at some time during the day. In both cases the improved overview offered by the Modal Day can lead to an adjustment of the treatment.

The user may feel lost in diabetes space, i.e. on top of Noise of Daily Doings, data collection and manual analysis are stressing him. Therefore issues are to be addressed at the spot, to avoid missing the big picture. The solution to the problem can be to use the Modal Day function to make an automatically data collection and graphically show the selected days overlaid. Characteristic patterns will show e.g. “high noons”, “low nights”, “chaotic Sundays” and “messy mornings”, which enables the user to make a Big Picture Planning.

As a prerequisite and as a background for understanding the invention, a diabetic patient has the following import actions during a day:

6:30—alarm-clock awakens
**** 6:35—injection or inhalation of short acting insulin
These data is automatically stored, i.e. as the amount of insulin and the type of insulin (e.g. concentration)
In a simpler drug administration device data may be manually entered to the Modal Day
6:40—shower
**** 6:50—breakfast
7:15—off to work
**** 9:30—snack at a meeting
*** 11:45—blood glucose testing
When the patient tests his BG, i.e. blood glucose reading, the information may be automatically stored or manually entered to the Modal Day
**** 11:47—injection or inhalation of short acting insulin
These data is automatically stored, i.e. as the amount of insulin and the type of insulin
In a simpler drug administration device data may be manually entered to the Modal Day
**** 12:15—lunch
****14:50—blood glucose testing
This glucose data point is automatically or manually stored to the Modal Day.
**** 15:00—afternoon snack—fruit
****15:10—blood glucose testing
This glucose data point is automatically or manually stored to the Modal Day.
****15:15—short acting insulin
These data is automatically or manually stored, i.e. as the amount of insulin and the type of insulin to the Modal Day
16:00—off from work
**** 16:20—exercise in fitness club
**** 17:25—blood glucose testing
This information, i.e. the blood glucose level may be automatically stored or manually entered to the Modal Day
**** 17:30—fruit
**** 18:30—blood glucose testing
The blood glucose level may be automatically stored or manually entered to the Modal Day
****18:35—injection or inhalation of short acting insulin
Again, these data is automatically or manually stored, i.e. as the amount of insulin and the type of insulin (short acting) to the Modal Day
**** 19:00—supper
**** 20:30—coffee
**** 23:30—blood glucose testing
This information may be automatically stored or manually entered to the Modal Day
**** 23:35—injection or inhalation of long acting insulin before the night
Again, these data is automatically or manually stored, i.e. as the amount of insulin and the type of insulin (long acting) to the Modal Day.

For both glucose values and insulin taken the corresponding time stamps (year, month, day, hour, minute) are to be stored with the data points. Additionally, the same applies for exercises and meals or other intake of food and beverages.

The items—marked with ****—are of interest prior to the use of the Modal Day and these are some way entered to the underlying data base for the Modal Day, which may be accessed and used according to the invention from said drug administration device.

Data as above indicated with **** and typically from more days (dates) then comprise the users' diary data.

As will be discussed in more details later, blood glucose data and intake or insulin intakes, respectively with their time stamps are entered in the modal day format as diary data, which thus comprises one or more insulin intakes with corresponding one or more related glucose measurements for the same dates with related time stamps, further the diary day may comprise meal and exercise.

Or, the other way around, one or more related glucose measurements with corresponding one or more insulin intakes are entered in the modal day format with related time stamps.

In all cases, it is a prerequisite that said data are available for carrying out the invention on said drug administration device.

The drug administration device may be a doser for injection of insulin in various concentrations, it may be in a simpler form as an electronic syringe equipped with displaying capabilities. For example U.S. Pat. No. 6,540,672, WO0032258, WO0191833 and WO2003005891 all disclose intelligent drug administration devices, (which are hereby incorporated by reference in its entirety).

The invention may as well be carried on a drug administration device in form of a pump also capable of infusing insulin in various concentrations as general known in the art. Alternatively, the drug administration device may be an inhalation device: various inhalation devices exist that aid in depositing a liquid aerosol or dry aerosol powder into a patient's lungs. For example, U.S. Pat. No. 5,888,477 (which is hereby incorporated by reference in its entirety) discloses an inhaler with robust features that may be used for insulin delivery. U.S. Pat. No. 5,785,049 to Smith et al. (which is hereby incorporated by reference in its entirety) discloses a device suitable for powdered medication delivery.

### BRIEF DESCRIPTION OF THE FIGURES

FIGS. 1 (a) and (b) shows sample graphs for Blood Glucose and Insulin for a predetermined period of time.

FIG. 2 shows a general computing device on which the invention can be practiced.

FIG. 3 is a flowchart of the method as defined by the invention.

FIGS. 4 (a) and (b) shows the graphs generated in accordance with the invention.

FIG. 5 shows another graph with lines connecting points in accordance with the invention.

### DETAILED DESCRIPTION OF THE FIGURES

As mentioned earlier Modal Day plot shows the data readings by time of day over the time range that is selected: day, week, month, quarter and year. The distribution of data points indicates the general pattern of the data. Any deviations can be easily discovered visually.

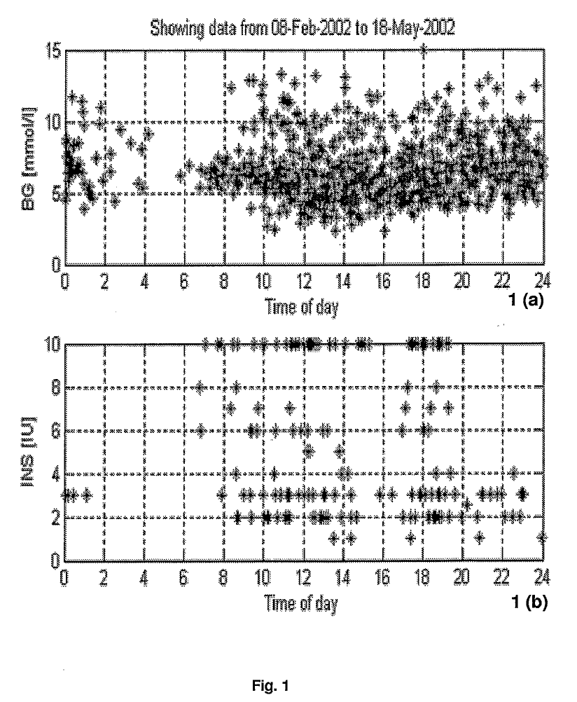

Two such simple graphs are shown in FIG. 1. FIG. 1 (a) shows the distribution of data points representing Blood Glucose readings (in mmol/l) for the period 8 Feb. 2002 to 18 May 2002. These data points are charted against an x-axis representing hour (time) of the day at 2 hour intervals. Similarly FIG. 1(b) charts insulin intake.

It is desirable that one or more of a group of abnormal or just interesting data points be selected and other corresponding data points from the same day are automatically highlighted so that a patient gets an insight into these special data relations. For example a patient might discover that on some particular days (such as Sunday) his blood glucose is higher, or he is exercising less on Mondays etc.

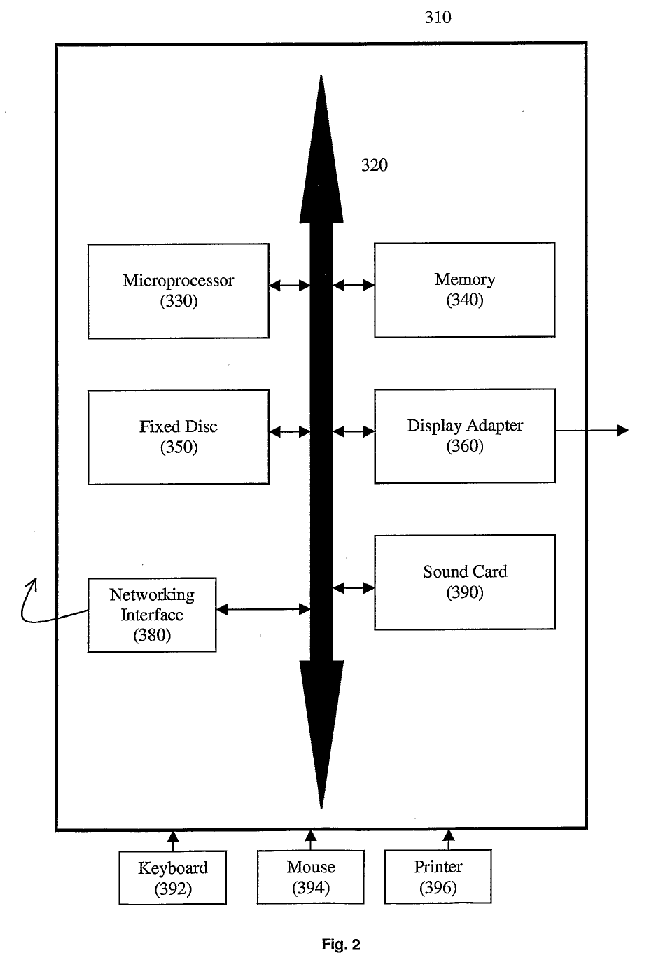

The invention provides for such a method and a drug administration device that incorporate this insight functionality into a Modal Day Graph. This computer implemented method can be run on any general purpose computing device/computer system, e.g. on said drug administration device as previously discussed or as shown in FIG. 2 which shows its internal structure. The computer system (310) or drug administration device consists of various subsystems interconnected with the help of a system bus (320). The microprocessor (330) communicates and controls the functioning of other subsystems. Memory (340) helps the microprocessor in its functioning by storing instructions and data during its execution. As an example, the microprocessor may receive inputs (from keyboard (392) and/or a mouse (394)) which select one or more data points related to one or more dates, the microprocessor may then be used to compute corresponding data points (for example by means of a search in the memory (340)) and then mark these corresponding data point for a subsequent display on a display device, e.g. a display, monitor, screen. Fixed Drive (350) is used to hold the data (e.g. various data points) and instructions permanent in nature like the operating system and other programs. Display adapter (360) is used as an interface between the system bus and the display device (370), which is a monitor or a display. The network interface (380) is used to connect the computer with other computers on a network through wired or wireless means. These devices on the network can also be drug administration devices. The communication means can be wired or wireless, such as cable, RS232, Bluetooth, infrared etc using various communication protocols such as TCP/IP, SSL etc. The computer system or drug administration device might also contain a sound card (390). The system or drug administration device is connected to various input devices like keyboard (392) and mouse (394) and output devices like printer (396). Various configurations of these subsystems are possible. It should also be noted that a system implementing the present invention might use less or more number of the subsystems than described above.

As not shown on the figure, the drug administration device may further comprise means for injection of insulin in various selected concentrations, it may be equipped with a motor or a pump function to be capable of infusion of insulin. Alternatively, when the drug administration device is an inhalation device it may comprise means for providing a liquid aerosol or dry aerosol powder into the lungs of a diabetic patient. However, the drug administration device need not necessarily be used to provide insulin, it can primarily be used to select and mark data points according to the invention.

This arrangement between the drug administration device and the computing system from any of which the invention may be executed, i.e. the invention may reside on the drug administration device or on the computing system, or it may distributed between the two, i.e. the invention may transfer data between the two for display on of them or on both. But at the same time the invention can also be expanded and customized to other electronic devices as per the need to establish an efficient patient-doctor-relative-peer network. For example the computing system and/or the drug administration device may periodically logon to a Local Area Network, or Internet to transmit the user readings (data points) on a remote database server that might be used to generate reports from a different computing system such as that of a doctor, relative of the patient and the like. These computing devices can be general purpose desktops or other variations such as laptop, cell phones, PDAs, etc.

The method is incorporated in the aforementioned computing devices or the drug administration devices as by instructions in the software that are carried out by any of these. Again, the software may be implemented as one or more modules for implementing the method steps according to the invention.

In particular, the software may be stored in a computer readable medium, including the storage device or that is downloaded from a remote location via the interface and communications channel from the Internet or another network location or site. The computer system or the drug administration device includes the computer readable medium having such software or program code recorded such that instructions of the software or the program code can be carried out.

The computer system and/or the drug administration devices are provided for illustrative purposes and other configurations can be employed without departing from the scope and spirit of the invention. The foregoing is merely an example of the types of computers, the drug administration devices or computer systems with which the embodiments of the invention may be practiced. Typically, the processes of the embodiments are resident as software or a computer readable program code recorded on a hard disk drive as the computer readable medium, and read and controlled using the control module. Intermediate storage of the program code and any data including entities, tickets, and the like may be accomplished using the memory, possibly in concert with the storage device.

In some instances, the program may be supplied to the user encoded on a CD-ROM or a floppy disk (both generally depicted by the storage device), or alternatively could be read by the user from the network via a modem device connected to the computer. Still further, the computer system can load the software from other computer readable media. This may include magnetic tape, a ROM or integrated circuit, a magneto-optical disk, a radio or infra-red transmission channel between the computer and another device, a computer readable card such as a PCMCIA card, and the Internet and Intranets including email transmissions and information recorded on Internet sites and the like. The foregoing are merely examples of relevant computer readable media. Other computer readable media may be practiced without departing from the scope and spirit of the invention.

The executing steps can be realised in a centralised fashion in one computer system or in a distributed fashion where different elements are spread across several interconnected computer systems, e.g. interconnected drug administration devices. Computer program means or computer program in the present context mean any expression, in any language, code or notation, of a set of instructions intended to cause a system having an information processing capability to perform a particular function either directly or after either or both of the following: a) conversion to another language, code or notation or b) reproduction in a different material form.

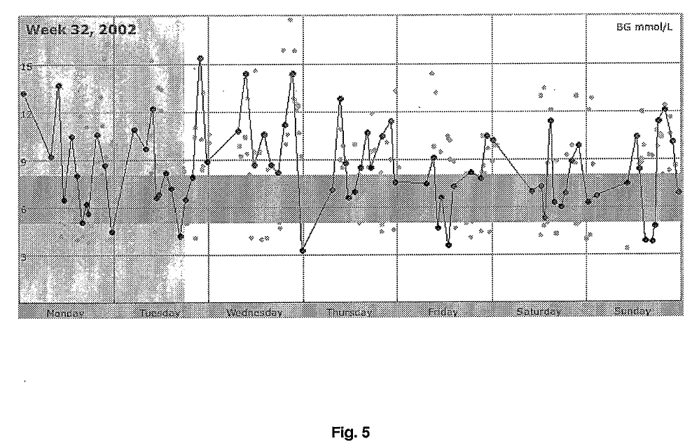

The invention is a method that builds upon the existing modal graphs (displaying data such as blood glucose, insulin intake, exercise, meal, etc.). The graphs can be in the form of a point graph, a bar graph, a line graph etc. As per the invention the user can select one or more data points on the modal day presentation. This selection is preferably done using a pointing device such as a mouse, trackball and the like but other devices can also be used for the same. Once selected, the data points are marked, e.g. highlighted in a different color (from the rest of the data points) and all the points corresponding to the selected points are also marked. This gives the user an insight of the day's readings. As alternatives or an addition to highlighting, a circle, a star, a figure, a dot, a small pictogram, a blinking data point, etc or other means may be used to indicate or mark data points of interest. E.g. a data point is surrounded by a circle or a star, alternatively a figure, a dot or a pictogram is added onto during the presentation of the data point. Further, points may be connected with line(s) relating to the same selected period as will be shown in FIG. 5.

Through the application the term marking will apply as discussed above.

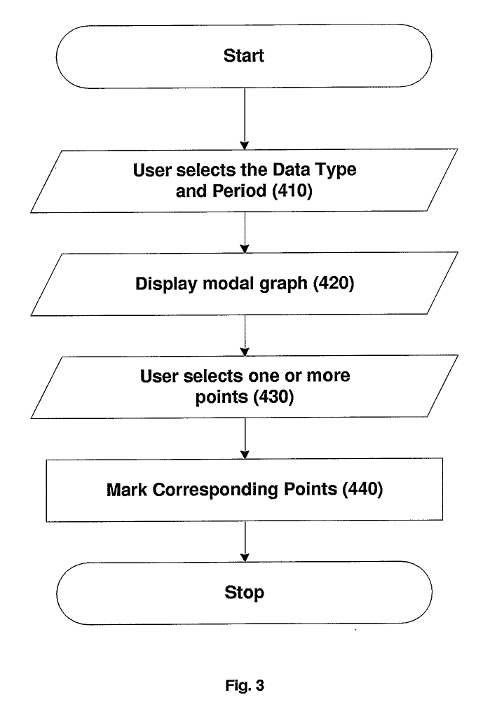

FIG. 3 is a flowchart of the method as per the invention. The user initiates the modal day graph generation process by first selecting the kind of data and the period (i.e. date range) (410) for which graph is to be generated. In case of diabetes this data can be Blood Glucose reading, Insulin intake, concentration of insulin intake (e.g. long acting insulin, short acting insulin, or mixes thereof), meal, exercise, etc. The period can be in days, quarter, months, years etc. On user selection a modal day graph is generated and displayed (420). User can select one or more data points (430) for which he requires detailed insight. After selection, other data points from the same day are highlighted (440), i.e. same kind of marking as discussed above or by means of said alternatives

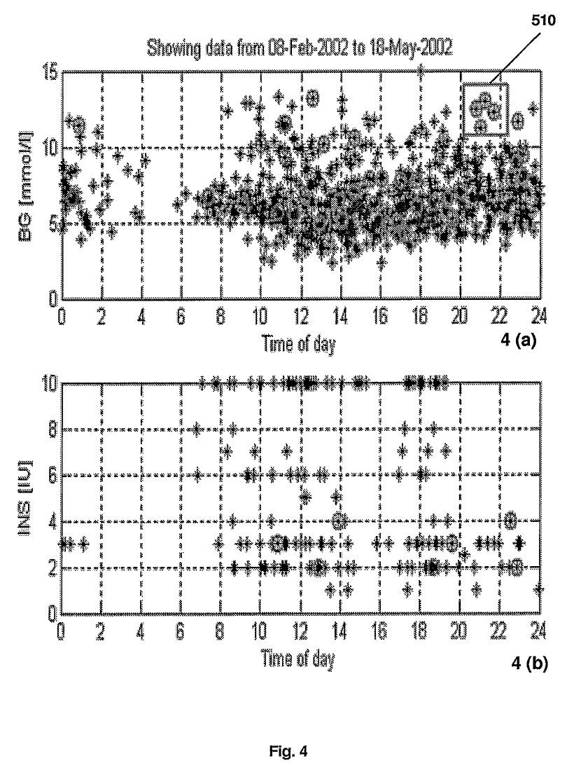

FIG. 4 shows one of the sample display and interfaces that can be achieved using the invention. In FIG. 4 (a) corresponds to FIG. 1 (a), shows four data points that are selected by dragging a box around them (510), the selected four data points, in this case and in general represents data from one or more dates.

When the read color is applied to mark, these data points are colored red, as well as other corresponding data points which are also colored red. FIG. 4 (b) shows similar marking of the data points. It is possible to choose between different markings i.e. one style or kind of marking may be applied to mark the selected data points, whereas another style or kind of marking may be applied to mark the corresponding data points. A key explanation may tell what the marking(s) is/are to indicate.

As shown on the figure, some glucose measurements (four) from 20 to 22 are selected, where corresponding and relating amounts of insulin taken are marked from the same four dates, assuming that in each of these four days only one single glucose measurement was taken each day between 20 and 22.

On FIGS. 1 and 4 Blood glucose and insulin intake, respectively are shown on the y-axis. Glucose and insulin intake may be swapped. Thus, the invention may be applied the other way around, i.e. data points representing insulin intake in IU, i.e. in International Units, may be selected representing one or more dates, where then the corresponding and relating glucose measurements (concentration, mmol/l) as a response—by the drug administration device on which the invention is carried out—are marked for the same date(s).

In general, data may be in a modal day format, i.e. data may represent insulin intake on the one hand with corresponding related glucose measurements, or as disclosed in FIG. 4, the other way round: i.e. data may represent glucose measurements with corresponding related insulin intakes. In all cases, the modal day format comprises one or more insulin intakes with corresponding one or more related glucose measurement for the same dates and vice versa.

In another embodiment of the invention, i.e. on FIGS. 1 and 4 meal and Insulin intake, respectively could be shown on the y-axes instead.

In another embodiment of the invention, i.e. on FIGS. 1 and 4 meal and blood glucose, respectively could be shown on the y-axes instead.

In another embodiment of the invention, i.e. on FIGS. 1 and 4 exercise and Insulin intake, respectively could be shown on the y-axes instead.

In another embodiment of the invention, i.e. on FIGS. 1 and 4 exercise and blood glucose, respectively could be shown on the y-axes instead.

In another embodiment of the invention, i.e. on FIGS. 1 and 4 meal and exercise, respectively could be shown on the y-axes instead.

As an alternative or as an addition, exercise related data may be applied correspondingly; relations may be built between blood glucose and insulin injections with exercise. Correspondingly, blood glucose and insulin injections are then marked when exercise data points were first selected and vice versa.

As an alternative or an addition, meal related data may be applied correspondingly; another relation may be built between blood glucose and insulin injections with meal. Correspondingly, blood glucose and insulin injections are then marked when meal data points were first selected and vice versa.

As another example, again another relation between blood glucose and meals can be created and applied according to the invention. Correspondingly, blood glucose data points are then marked when meal data points were first selected and vice versa.

As an example, a relation between insulin intake and exercise can be created and applied according to the invention. Correspondingly, insulin intake data points are then marked when exercise data points were first selected and vice versa.

As an example, a relation between meals and exercise can be created and again be applied according to the invention. Correspondingly, meals data points are then marked when exercise data points were first selected and vice versa.

Thus in a generalized form, one or more data points from one (or more up to three) of the following four data items: blood glucose, insulin injections, meal and exercise may be selected representing data from one or more dates, and as a result—by means of the drug administration device on which the invention is carried out—one or more data points of the up to three unselected data items is/are then marked corresponding to the dates of the selected data points, i.e. if one data item is marked if three data items were selected, two data items are marked if the two other data items were selected, and three data items are marked if one data item was selected, all marked data item(s) with corresponding relating data points.

Thus, in the most generalized form, on FIGS. 1 and 4 data item 1 and data item 2, respectively are shown on the y-axis. Data item 1 could be any one of blood glucose, insulin injections, meal and exercise, correspondingly for data item 2. These may be swapped still applying the idea of the invention, i.e. select data point from one data item e.g. data item 1 and then corresponding related data points from the other data item, e.g. data item 2 are then marked according to the idea of the invention.

In one embodiment of the invention different days, i.e. dates can be highlighted in different colors and a key can be provided that would give the date along with the color in which it is highlighted), i.e. some explanation, the key is provided indicating the kind of marking applied.

In another embodiment, only the data points from the selected dates can be shown, hiding others. In this way a comparison of anomalous or just interesting days can be done against an ideal day. E.g. days with high glucose levels or very low levels could be such interesting day, accordingly days with high insulin intakes or little intake would be days of interest.

FIG. 5 shows another graph with lines connecting points in accordance with the invention. As is apparent from the graph, lines connect points representing blood glucose measurements, all related to the same week. Here the patient, health care personal, etc can see whether the blood glucose measurements from week 32, 2002 is on average, below or higher as compared to other data from other weeks.

The same principle—of connecting points with line(s) relating to the same selected period—could apply for meal, exercise and for insulin intake as well.

The foregoing describes only some of the various possible embodiments of the present invention, and modifications and/or changes can be made thereto without departing from the scope and spirit of the invention, the described embodiments being illustrative and not restrictive. Although the invention has been explained using diabetes as a central theme, however the invention is no way restricted to the field of diabetes. The use of a central example is to bring clarity and uniformity. The invention is equally effective in other similar application including (but once again not restricted to) general health monitoring. The aforementioned figures and their explanation are meant to be only illustrative and are used as examples and aids to explain the invention lucidly and are in no way meant to limit the invention or take away from its essence which is hereinafter specifically stated in the following claims.

1. A method for graphically displaying diary data in a modal day format, said method characterized by the steps:
selecting one or more data points (430) of one or more of the diary data by the user, said points representing data from one or more dates, and
marking all other data points (440) corresponding to the dates of the selected data points.

2. The method of claim 1, characterized in that diary data comprises blood glucose, insulin intake, meal and exercise, all with a time stamp.

3. The method of claim 1, characterized in that diary data consists of blood glucose and insulin intake, both with a time stamp.

4. The method of claim 1, characterized in that the marking of the data points is achieved by color-coding or highlighting or that the marking is achieved in that the data points are surrounded by a circle or a star, alternatively a figure, a dot or a pictogram is added onto the presentation of said data points, or a line is used to connect data points.

5. The method of claim 1, characterized in that said method further comprises the step of:
showing only the data points from the selected dates and hiding others.

6. A drug administration device for graphically displaying diary data in a modal day format, characterized by:
means for selecting one or more data points of one or more of the diary data by the user, said points representing data from one or more dates, and
means for marking all other data points corresponding to the dates of the selected points.

7. The drug administration device of claim 6, characterized in that diary data comprises blood glucose, insulin intake, meal and exercise, all with a time stamp.

8. The drug administration device of claim 6 characterized by that diary data consists of blood glucose and insulin intake, both with a time stamp.

9. The drug administration device of claim 6, characterized in that means for marking the data points includes color-coding or highlighting or that the marking is achieved in that the data points are surrounded by a circle or a star, alternatively a figure, a dot or a pictogram is added onto the presentation of said data points, or a line is used to connect data points.

10. The drug administration device of claim 6, characterized by means for showing only the data points from the selected dates and hiding others.

11. The drug administration device of claim 6, wherein the aforementioned means wholly or partially reside on a computing system comprising:
at least one system bus,
at least one communications unit connected to the system bus,
at least one memory unit including a set of instructions, said unit connected to the system bus, and
at least one control unit executing the instructions in the memory for the functioning of said means.

12. A computer program product comprising computer readable program code stored on a computer readable storage medium embodied therein for graphically displaying diary data in a modal day format, said computer program product characterized by:
computer readable program code means configured for selecting one or more data points of one or more of the diary data by the user, said data points representing data from one or more dates, and computer readable program code means configured for marking all other data points corresponding to the dates of the selected data points.

13. A computer program product according to claim 12,
computer readable program code means configured for selecting one or more data points of blood glucose data by the user, said points representing data from one or more dates, and
computer readable program code means configured for marking insulin intake corresponding to the dates of the selected data points.

14. The computer program product of claim 12, characterized in that the computer readable program code means configured for marking the data points includes computer readable program code for color-coding or highlighting or such that the data points are surrounded by a circle or a star, alternatively a figure, a dot or a pictogram is added onto the presentation of said data points, or a line is used to connect data points.

15. The computer program product of claim 12, characterized by the computer readable program code means configured for showing only the data points from the selected dates and hiding others.
